(19) United States
(12) Patent Application Publication
(10) Pub. No.: US 2023/0306488 A1
(43) Pub. Date: Sep. 28, 2023

(54) Product Information Extraction Systems And Methods

(71) Applicant: EQUALLEVEL, INC., Rockville, MD (US)

(72) Inventors: Edward Potocoko, Rockville, MD (US); Matthew Guenzel, Montgomery Village, MD (US)

(73) Assignee: EQUALLEVEL, INC., Rockville, MD (US)

(21) Appl. No.: 18/011,700

(22) PCT Filed: Jun. 27, 2021
(86) PCT No.: PCT/US2021/039285

§ 371 Date: Dec. 20, 2022

Related U.S. Application Data
(60) Provisional application No. 63/044,684, filed on Jun. 26, 2020.

(51) Int. Cl. G06Q 30/0601

(52) U.S. Cl. CPC G06Q 30/0629

(57) ABSTRACT

Systems and methods for obtaining online product information from multiple vendors and providing users with a normalized pricing schema to enhance user purchasing decisions. Exemplary systems can traverse the Internet and other networks to scrape and/or otherwise collect data from various product listings which can then be used to generate a database of varying products and corresponding attribute data. This data may then be compared and normalized to provide product comparisons (i.e. cost) to a user even though the originally gathered data may have had different units of data between the products (i.e. package quantity, size, etc).

### BACKGROUND

Online e-commerce continues to become more popular and has increased year over year since at least 2008. Some estimates have online retail constituting over 20% of market share by 2022. One form of online shopping includes the use of procurement systems in which users can purchase products they need for their business or occupation. These systems allow users to search for, view and purchase products from a variety of vendors. However, due to varying prices offered by different vendors at varying package quantities for different but similar products, all of which are constantly changing, it is difficult for users to determine the best price. This holds true even for identical products manufactured by the same manufacturer but listed with different vendors in different packages. This problem is compounded in the present-day eProcurement landscape as sellers typically do not provide enough structured product information for a user to determine how much of an item they are selling. Sellers provide product information in the form of catalog files (CSV/XML) or PunchOut sites (cXML/OCI). While these formats can contain unit of measure and Package Quantity fields, they are often inaccurate and do not provide enough information to determine the true quantity of a product offering.

### SUMMARY OF THE INVENTION

Described herein are systems and methods for obtaining online product information from multiple vendors and providing the user with a normalized pricing schema to enhance user purchasing decisions. Exemplary systems can traverse the Internet and other networks to scrape and/or otherwise collect data from various product listings which can then be used to generate a database of varying products and corresponding attribute data. This data may then be compared and normalized to provide product comparisons (i.e. cost) to a user even though the originally gathered data may have had different units of data between the products (i.e. package quantity, size, etc).

The foregoing paragraphs have been provided by way of general introduction, and are not intended to limit the scope of the following claims. Therefore, the above summary is not intended to be an exhaustive discussion of all the features or embodiments of the present disclosure. A more detailed description of the features and embodiments of the present disclosure will be described in the detailed description section.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 a diagram of an environment for a product information extraction system according to one example.

FIG. 2A is a flowchart illustrating a method of operation of the product information extraction system according to one example.

FIG. 2B is a flow chart illustrating a process for training a NER model according to one example.

FIG. 3 illustrates various aspects of an exemplary architecture implementing a platform for the product information extraction system according to one example.

FIG. 4 illustrates the architecture of the Central Processing Unit (CPU) of FIG. 3 according to one example.

FIG. 5 illustrates a distributed system for connecting user computing devices with the platform of FIG. 3 according to one example.

### DETAILED DESCRIPTION

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

It will be appreciated that as used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

It will also be appreciated that as used herein, any reference to a range of values is intended to encompass every value within that range, including the endpoints of said ranges, unless expressly stated to the contrary.

As described further herein, aspects of the present invention are described below with reference to flowchart illustrations and/or block diagrams of methods, apparatus (systems) and non-transitory computer-readable mediums according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, an operating system, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, a processor, other programmable data processing apparatus, or other devices to cause a series of operational steps to be performed on the computer, the processor, or other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring now to the drawings, wherein like reference numerals designate identical or corresponding parts throughout the several views, the following description relates to a dedicated system and method for collating product data and corresponding attributes and processing the data to provide users with same-unit product comparisons.

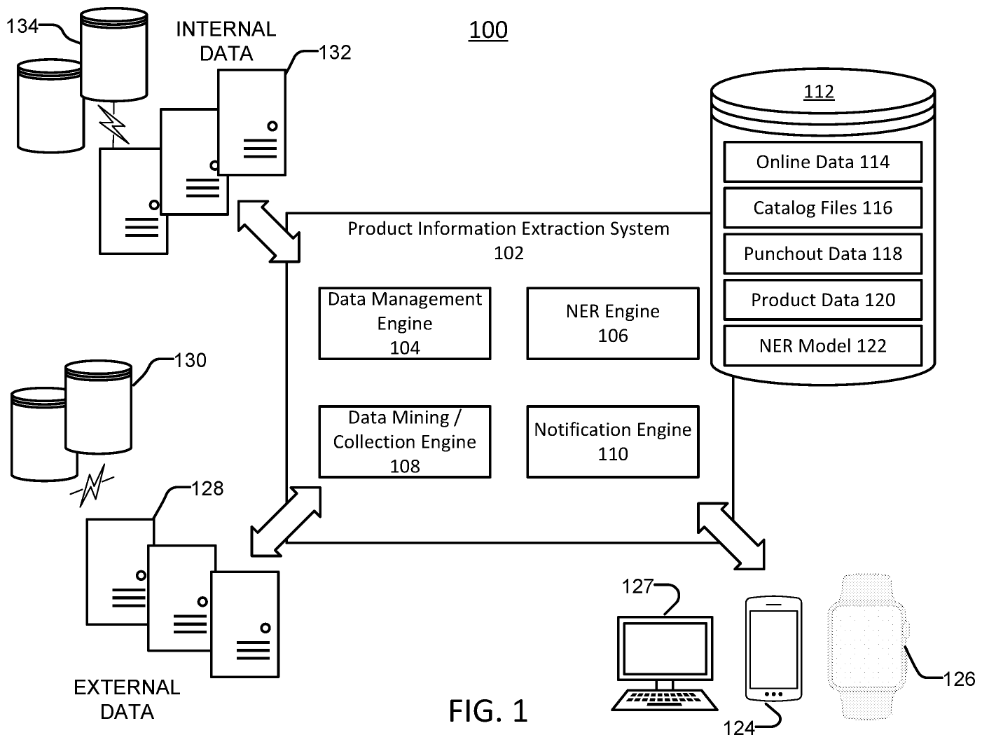

FIG. 1 is a diagram of an environment 100 for a product information extraction system 102 according to one example. As illustrated in FIG. 1, the environment 100 includes the product information extraction system 102 connected to one or more databases 112 and further being connected to a plurality of devices or systems including, but not limited to, mobile devices 124, wearable devices 126 and computing devices 127 of the user and/or other users, external data systems having one or more servers 128 connected to one or more databases 130, and internal data systems having one or more servers 132 connected to one or more databases 134. The devices 124-127 can be controlled by the user or other users and can have mobile application software installed for interfacing with the product information extraction system 102. Alternatively, the computing devices 127 can have local software installed for interfacing with the product information extraction system 102 or can interface via a web-based platform as would be understood by one of ordinary skill in the art. Further, in one example, the product information extraction system 102 software itself, without or without the contents of the database 112, can be installed entirely on one or more of the devices 124-127. In other words, the software installed on the devices 124-127 can include programming for the entire product information extraction system 102 such that the processes described herein are performed entirely on one or more of the devices 124-127. However, as illustrated in FIG. 1, in one example, the product information extraction system 102 is separate from the devices 124-127 and receives information from these devices 124-127 via their application interface. The product information extraction system 102 can then return results of the processes described herein to the user at the devices 124-127. Thus, although discussed together, the disclosure herein contemplates the devices 124-127 working individually or together with the product information extraction system 102.

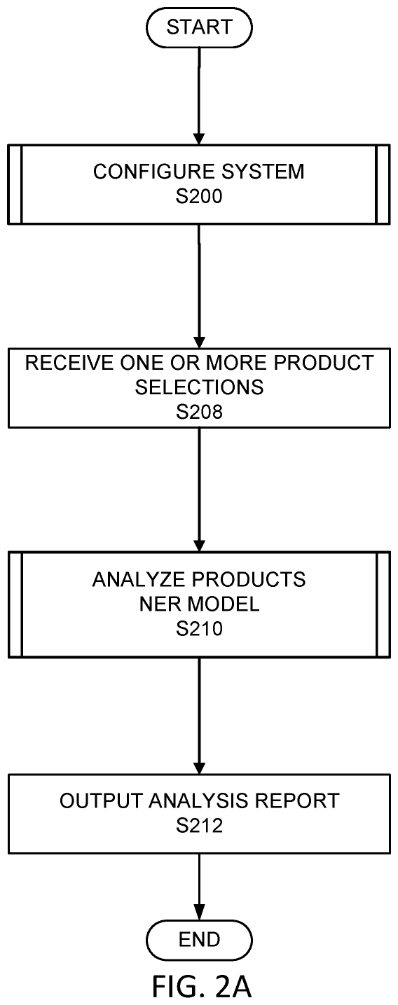

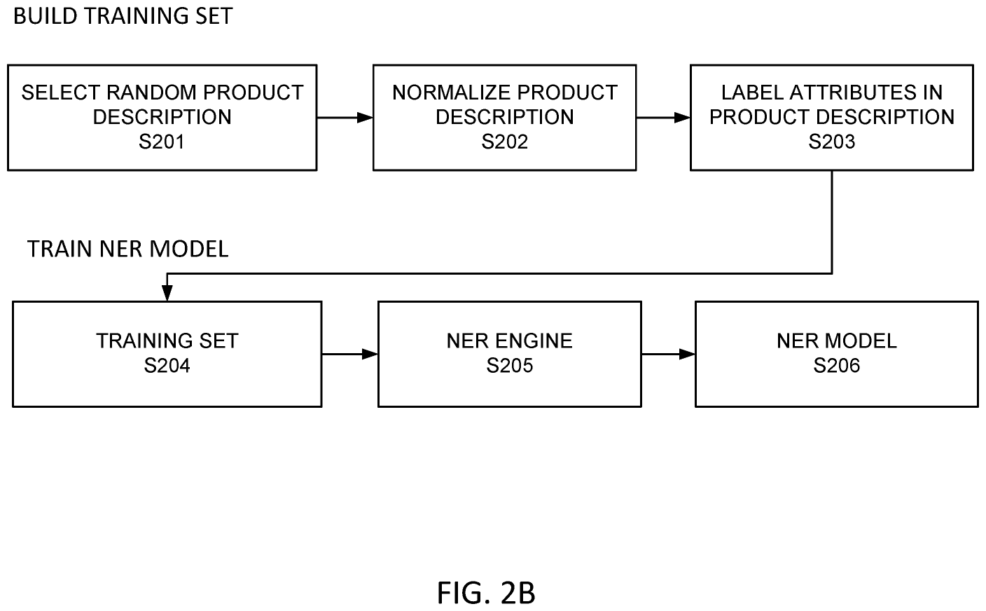

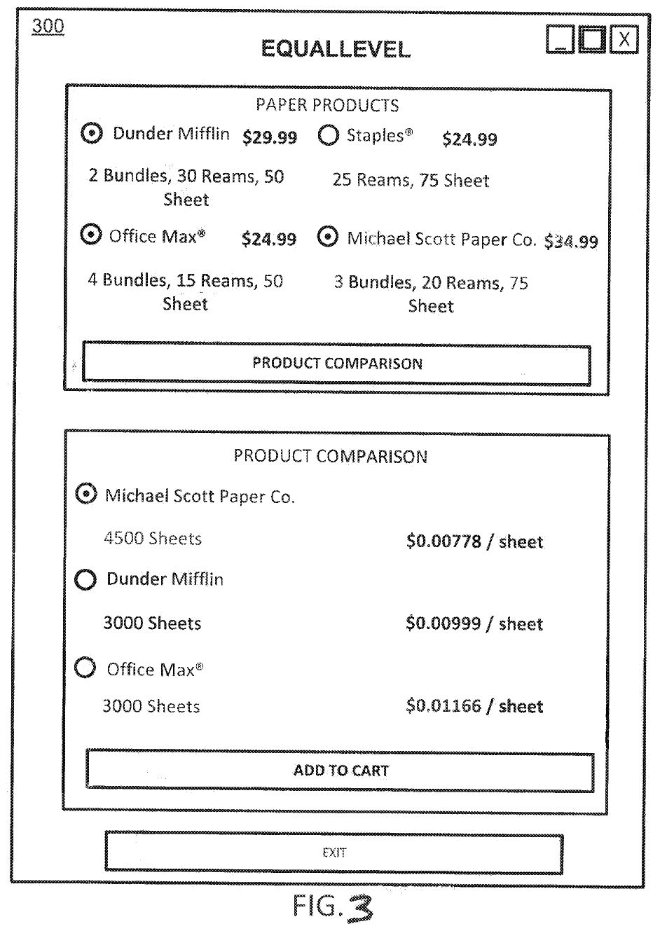

The product information extraction system 102 includes a data management engine 104, data mining/collection engine 108, a Named Entity Recognition (NER) engine 106, and a notification engine 110. The data management engine 104 controls the overall functionality of the product information extraction system 102 by communicating with and controlling the data mining/collection engine 108, the NER engine 106 and the notification engine 110. The functionality of the product information extraction system 102 will now be discussed in conjunction with exemplary methodology of its implementation as discussed in FIGS. 2A and 2B.

Initially at step S200 of FIG. 2 (and throughout operation of the product information extraction system 102), the data management engine 104 will control configuration of the system by controlling the data mining/collection engine 108 to obtain product description information both from internal data stored on databases 134, such as catalog files 116 and punchout data 118 and external data stored on databases 130 such as online data 114 obtained via web-crawling, web-scraping from various websites and/or via Application Programming Interfaces (APIs) as would be understood by one of ordinary skill in the art. Catalog files 116 and punchout data 118 could also be stored externally on databases 130. The obtained data can then be stored in database 112 of the product information extraction system 102 as online data 114, catalog files 116 and punchout data 118.

Once the data is obtained and accessible by the product information extraction system 102, the data management engine 104 can continue the process of system configuration by controlling the NER Engine 106 to train an NER model using portions of the obtained data. NER is a subtask of information extraction that seeks to locate and classify named entities mentioned in unstructured text into pre-defined categories such as person names, organizations, locations, medical codes, time expressions, quantities, monetary values, percentages, etc. This can include taking an unannotated block of text and producing an annotated block of text that highlights the names of the entities and relationships therebetween. However, it should be noted that other statistical models could be implemented such as the Hidden Markov Model (HMI), Maximum Entropy (ME), and Conditional Random Fields (CRF).

Accordingly, at step S201 and in furtherance of step S200, building of a training set for the NER model is commenced. This can include the data management engine 104 analyzing the online data 114, catalog files 116 and punchout data 118 previously obtained at step S200 and stored in database 112. Alternatively, or in addition to, it can include the data management engine 104 continuously controlling the data mining/collection engine 108 to obtain new online data 114, catalog files 116 and punchout data 118 to ensure that the data is up to date and that it can be used to train an updated NER model. Once the data is analyzed, the data management engine 104 generates product data 120 and stores the product data 120 in database 112. Product data 120 can also be obtained by system controllers manually navigating and reviewing the internal and external data. The product data 120 can include data parsed and extracted from product description information from a randomly selected product description and can include attributes relating to the product name, type of product, part number, manufacturer, vendor, dimensions, copyright/trademark symbols, quantity and a unit of measurement corresponding to the quantity.

Once the product data 120 is obtained for a particular product description, the data management engine 104 normalizes the product data 120 at step S202 to standardize the display of common elements such as dimensions, units of measure, and copyright/trademark symbols. Product descriptions may contain multiple quantities and units of measure for packages of packages or packages containing multiple items in measured amounts. The product data 120 can therefore be categorized when building the training set as being one item, a package, an amount, a package of packages or a package of amounts. Each of the attributes of the product description are then ascribed a corresponding label at step S203 for use by the NER model. The steps of S201-S203 are then repeated for a multitude of product descriptions to complete the build of the training set.

At step S204, the training set is fed into the NER Model engine 106 by the data management engine 104 which controls the NER model engine 106 to generate and train the NER model 122 and store it in the database 112. Accordingly, at step S205, the process of training the NER model 122 takes place to continuously update the product data 120 used by the NER model to make the model smarter at identifying particular types of data obtained from various sources of product description information such as the external data and internal data. Once enough of the training set data is processed at step S205, the NER engine 106 completes initial training of the NER model 122 at step S206 and updates it in database 122. Completion can be determined by feeding test data into the NER model 122 and analyzing output data generated by the data management engine 104 to known valid data to determine if a threshold accuracy level has been met.

Referring back to FIG. 2, once the NER model 122 is trained, the system configuration processing initiated as step S200 is complete and the product information extraction system 102 is ready for use by users. Accordingly, at step S208, one or more product selections can be received by the product information extraction system 102 from users accessing the product information extraction system 102 from at least one of user devices 124-127.

FIG. 3 illustrates an interface 300 of the product information extraction system 102 according to one example in which a user has selected various products for analysis by the product information extraction system 102. In this example, a user is looking to purchase paper but the product description for each product is different thereby making it unclear to the user as to what is the best deal and how the varying quantity amounts come into play. Here, a user has selected three products and requested a product comparison by clicking on the product comparison button.

Once a selection of products is made at step S208, the process proceeds to step S210 where the data management engine 104 analyzes the selected products via the NER engine 106 using the trained NER Model 122 stored in database 112. The NER engine 106 uses the NER Model 122 to extract quantity and pricing information from product description data 120 which is normalized for easy comparison by the customer. Accordingly, when the user executes the product comparison button, the NER engine 106 inputs the product description data for each selection into the NER model 122 which has previously been trained as explained herein. The NER engine 106 then analyzes the product descriptions for each selected product, extracts the pertinent product data 120 (i.e. quantity and pricing information in this example) and correlates the product data 120 into the same type of units of measurement for review by the user.

Once the NER engine 106 generates the appropriate comparison data at step S210, the data management engine 104 controls the notification engine 110 to output at step S212 the processed data from the product information extraction system 102 to the user device 124-127 as illustrated in FIG. 3 under Product Comparison. Here, it can readily be seen what are the equivalent quantities of paper as compared to price based on product description information having different quantities in three different units of measurement between the products. Although it may have appeared more expensive in the product listing, Michael Scott Paper Co. naturally undersold the competition—likely at lower than cost. Based on this information, the user can make a better selection of which product to purchase based on their buying criteria (i.e. price and quantity). It should be noted that this is an example and that in certain implementations the system can automatically display the normalized data between products whether selected by the user or not and without the requirement for requesting a product comparison.

Accordingly, the product information extraction system 102 described herein can provide accurate data models to users based on product data extracted from external and internal product description data. The product information extraction system 102 can also avoid false positives in cases where the quantity of a posted package may change but the part number does not change. In this case, the product information extraction system 102 will not assume a certain quantity based on a past listing and part number but will have obtained updated product data 120 based on NER engine 106 analysis of updated product description data retrieved continuously by the data mining/collection engine 108.

Additionally, contemplated herein is that the product information extraction system 102 could use the NER Model 122 to automatically identify better deals for users based on a type of product or other attribute found in the product description relating to products selected by the user. This could also be extrapolated to complementary products (i.e. paper, pens, pencils) where price may come into play but convenience or business relationships may dictate that all the products come from one vendor thereby allowing the customer to make an informed decision outside of just price.

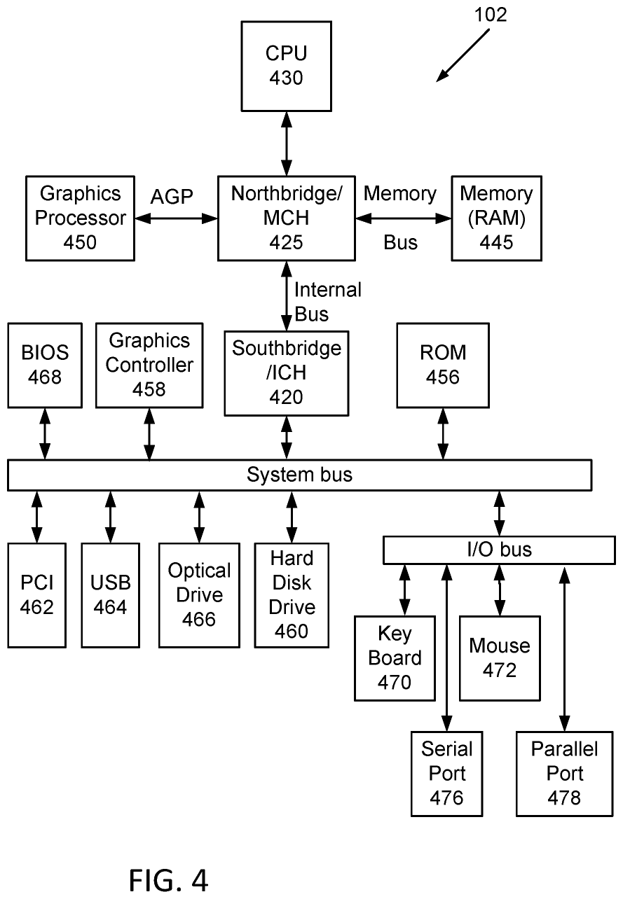

As noted herein, the product information extraction system 102 is connected to or includes processing circuitry of computer architecture. Moreover, processing circuitry configured to perform features described herein may be implemented in multiple circuit units (e.g., chips), or the features may be combined in circuitry on a single chipset, as shown on FIG. 4.

FIG. 4 shows a schematic diagram of a product information extraction system 102, according to certain examples, for controlling the product information extraction system 102 and providing the functionality as further described herein. The product information extraction system 102 is an example of a computer in which code or instructions implementing the processes of the illustrative embodiments may be located.

In FIG. 4, product information extraction system 102 employs a hub architecture including a north bridge and memory controller hub (NB/MCH) 425 and a south bridge and input/output (I/O) controller hub (SB/ICH) 420. The central processing unit (CPU) 430 is connected to NB/MCH 425. The NB/MCH 425 also connects to the memory 445 via a memory bus, and connects to the graphics processor 450 via an accelerated graphics port (AGP). The NB/MCH 425 also connects to the SB/ICH 420 via an internal bus (e.g., a unified media interface or a direct media interface). The CPU Processing unit 430 may contain one or more processors and even may be implemented using one or more heterogeneous processor systems.

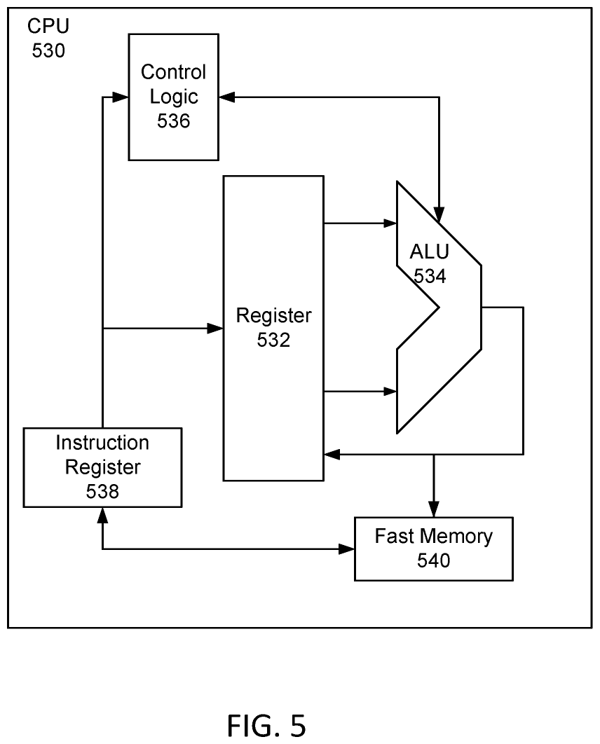

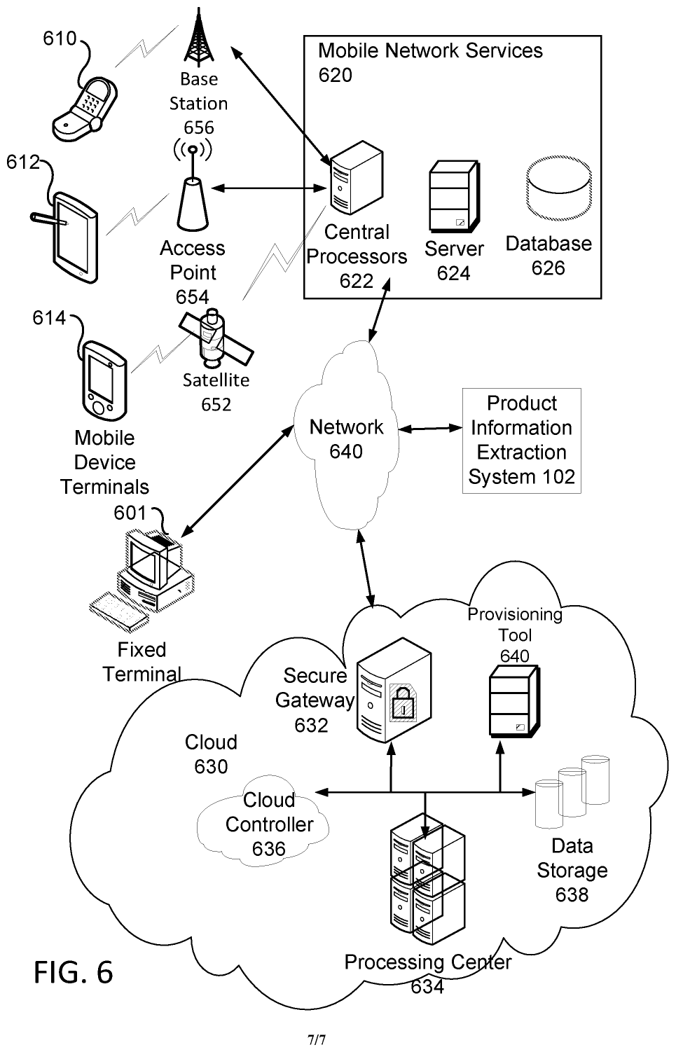

For example, FIG. 5 shows one implementation of CPU 530, identified in FIG. 4 as CPU 430. In one implementation, the instruction register 538 retrieves instructions from the fast memory 540. At least part of these instructions are fetched from the instruction register 538 by the control logic 536 and interpreted according to the instruction set architecture of the CPU 530. Part of the instructions can also be directed to the register 532. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 534 that loads values from the register 532 and performs logical and mathematical operations on the loaded values according to the instructions. The results from these operations can be feedback into the register and/or stored in the fast memory 540. According to certain implementations, the instruction set architecture of the CPU 430 can use a reduced instruction set architecture, a complex instruction set architecture, a vector processor architecture, a very large instruction word architecture. Furthermore, the CPU 430 can be based on the Von Neuman model or the Harvard model. The CPU 530 can be a digital signal processor, an FPGA, an ASIC, a PLA, a PLD, or a CPLD. Further, the CPU 430 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 4, the product information extraction system 102 can include that the SB/ICH 420 is coupled through a system bus to an I/O Bus, a read only memory (ROM) 456, universal serial bus (USB) port 464, a flash binary input/output system (BIOS) 468, and a graphics controller 458. PCI/PCIe devices can also be coupled to SB/ICH 420 through a PCI bus 462.

The PCI devices may include, for example, Ethernet adapters, add-in cards, and PC cards for notebook computers. The Hard disk drive 460 and CD-ROM 466 can use, for example, an integrated drive electronics (IDE) or serial advanced technology attachment (SATA) interface. In one implementation the I/O bus can include a super I/O (SIO) device.

Further, the hard disk drive (HDD) 460 and optical drive 466 can also be coupled to the SB/ICH 420 through a system bus. In one implementation, a keyboard 470, a mouse 472, a parallel port 478, and a serial port 476 can be connected to the system bus through the I/O bus. Other peripherals and devices that can be connected to the SB/ICH 120 using a mass storage controller such as SATA, SAS, Fibre channel or PATA, an Ethernet port, an ISA bus, a LPC bridge, SMBus, a DMA controller, a Video Codec and an Audio Codec.

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 6, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

FIG. 6 shows an example of cloud computing, having various devices interconnected to each other via a network and cloud infrastructures. Similarly, FIG. 6 shows a PDS 612 and a cellular phone 614 connected to the mobile network service 620 through a wireless access point 654, such as a femto cell or Wi-Fi network. Further, FIG. 6 shows the product information extraction system 102 connected to the mobile network service 620 through a wireless channel using a base station 656, such as an Edge, 3G, 4G, or LTE Network, for example. Various other permutations of communications between the types of devices and the mobile network service 620 are also possible, as would be understood to one of ordinary skill in the art. The various types of devices, such as the cellular phone 614, tablet computer 616, or a desktop computer, can also access the network 640 and the cloud 630 through a fixed/wired connection, such as through a USB connection to a desktop or laptop computer or workstation that is connected to the network 640 via a network controller, such as an Intel Ethernet PRO network interface card from Intel Corporation of America, for interfacing with a network.

Signals from the wireless interfaces (e.g., the base station 656, the wireless access point 654, and the satellite connection 652) are transmitted to and from the mobile network service 620, such as an EnodeB and radio network controller, UMTS, or HSDPA/HSUPA. Requests from mobile users and their corresponding information as well as information being sent to users is transmitted to central processors 622 that are connected to servers 624 providing mobile network services, for example. Further, mobile network operators can provide services to the various types of devices. For example, these services can include authentication, authorization, and accounting based on home agent and subscribers' data stored in databases 626, for example. The subscribers' requests can be delivered to the cloud 630 through a network 640.

As can be appreciated, the network 640 can be a public network, such as the Internet, or a private network such as an LAN or WAN network, or any combination thereof and can also include PSTN or ISDN sub-networks. The network 640 can also be a wired network, such as an Ethernet network, or can be a wireless network such as a cellular network including EDGE, 3G and 4G wireless cellular systems. The wireless network can also be Wi-Fi, Bluetooth, or any other wireless form of a communication that is known.

The various types of devices can each connect via the network 640 to the cloud 630, receive inputs from the cloud 630 and transmit data to the cloud 630. In the cloud 630, a cloud controller 636 processes a request to provide users with corresponding cloud services. These cloud services are provided using concepts of utility computing, virtualization, and service-oriented architecture. Data from the cloud 630 can be accessed by the product information extraction system 102 based on user interaction and pushed to user devices 610, 612, and 614.

The cloud 630 can be accessed via a user interface such as a secure gateway 632. The secure gateway 632 can, for example, provide security policy enforcement points placed between cloud service consumers and cloud service providers to interject enterprise security policies as the cloud-based resources are accessed. Further, the secure gateway 632 can consolidate multiple types of security policy enforcement, including, for example, authentication, single sign-on, authorization, security token mapping, encryption, tokenization, logging, alerting, and API control. The cloud 630 can provide, to users, computational resources using a system of virtualization, wherein processing and memory requirements can be dynamically allocated and dispersed among a combination of processors and memories such that the provisioning of computational resources is hidden from the users and making the provisioning appear seamless as though performed on a single machine. Thus, a virtual machine is created that dynamically allocates resources and is therefore more efficient at utilizing available resources. A system of virtualization using virtual machines creates an appearance of using a single seamless computer even though multiple computational resources and memories can be utilized according increases or decreases in demand. The virtual machines can be achieved using a provisioning tool 640 that prepares and equips the cloud-based resources such as a processing center 634 and data storage 638 to provide services to the users of the cloud 630. The processing center 634 can be a computer cluster, a data center, a main frame computer, or a server farm. The processing center 634 and data storage 638 can also be collocated.

Obviously, numerous modifications and variations of the present invention are possible in light of the above teachings. It is therefore to be understood that within the scope of the appended claims, the invention may be practiced otherwise than as specifically described herein.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, some implementations may be performed on modules or hardware not identical to those described. Accordingly, other implementations are within the scope that may be claimed.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, and to enable others of ordinary skill in the art to understand the embodiments disclosed herein.

1: A product information extraction system comprising:
processing circuitry configure to
obtain product description data from one or more sources,
analyze the product description data to generate a training set,
feed the training set into an NER model to create a trained NER model,
receive, via a network, a plurality of product selections having different units of measurement within the product description data,
generate, via processing circuitry and the trained NER model, product comparison data having the same units of measurement for each selected product, and
serve, via the network, the product comparison data to the user.

2: The system according to claim 1 wherein the one or more data sources include online data obtained via one of web-crawling and web-scraping.

3: The system according to claim 1 wherein product data includes attributes relating to at least one of product names, types of products, part number, manufacturer, vendor, dimensions, quantity, and units of measurement.

4: The system according to claim 1 wherein said processing circuitry is configured to analyze the product data by normalizing the product data to standardize common attributes.

5: The system according to claim 1 wherein the product comparison data is generated by extracting selected attributes from product data and correlating the selected attributes into the same type of units of measurement.

6: A method for extracting and analyzing product information, the method comprising:
obtaining product description data from one or more sources;
analyzing the product description data to generate a training set;
feeding the training set into an NER model to create a trained NER model;
receiving, via a network, product selections having different units of measurement within the product description data;
generating, via processing circuitry and the trained NER model, product comparison data having the same units of measurement for each selected product; and
serving, via the network, the product comparison data to the user.

7: The method according to claim 1 wherein the one or more data sources include online data obtained via one of web-crawling and web-scraping.

8: The method according to claim 1 wherein product data includes attributes relating to at least one of product names, types of products, part number, manufacturer, vendor, dimensions, quantity, and units of measurement.

9: The method according to claim 1 wherein analyzing the product data includes normalizing the product data to standardize common attributes.

10: The method according to claim 1 wherein generating the product comparison data includes extracting selected attributes from product data and correlating the selected attributes into the same type of units of measurement.

11: A non-transitory computer-readable medium having stored thereon computer-readable instructions which when executed by a computer cause the computer to perform a method for extracting and analyzing product information, the method comprising:
obtaining product description data from one or more sources;
analyzing the product description data to generate a training set;
feeding the training set into an NER model to create a trained NER model;
receiving product selections having different units of measurement within the product description data;
generating, via the trained NER model, product comparison data having the same units of measurement for each selected product; and
serving the product comparison data to the user.

12: The method according to claim 11 wherein the one or more data sources include online data obtained via one of web-crawling and web-scraping.

13: The method according to claim 11 wherein product data includes attributes relating to at least one of product names, types of products, part number, manufacturer, vendor, dimensions, quantity, and units of measurement.

14: The method according to claim 11 wherein analyzing the product data includes normalizing the product data to standardize common attributes.

15: The method according to claim 11 wherein generating the product comparison data includes extracting selected attributes from product data and correlating the selected attributes into the same type of units of measurement.
